(19) United States
(12) Patent Application Publication
(10) Pub. No.: US 2003/0025234 A1
(43) Pub. Date: Feb. 6, 2003

(54) Hydrophobic fuel cell component

(75) Inventors: Jeffrey John Gough, Olmsted Township, OH (US); Robert Angelo Mercuri, Seven Hills, OH (US)

Correspondence Address: James R. Cartiglia, Graftech Inc., Brandywine West, 1521 Concord Pike, Suite 301, Wilmington, DE, 19803, US

(73) Assignee: Graftech Inc., Wilmington, DE (US)

(21) Appl. No.: 10/184,816

(22) Filed: Jun. 28, 2002

Related U.S. Application Data
(63) Continuation-in-part of application No. 09/872,685, filed on Jun. 1, 2001.

(51) Int. Cl. B29C 59/00

(52) U.S. Cl. 264/127; 264/129; 264/293; 264/284

(57) ABSTRACT

An method for producing a material useful for forming a component for an electrochemical fuel cell is provided. More particularly, the component is formed of a sheet of a compressed mass of expanded graphite particles. The component is treated with a water resistant additive sufficient to provide utility as a component in an electrochemical fuel cell. Preferably, the water resistant additive is a fluoropolymer material. More preferably, the water resistant additive is a polytetrafluoroethylene material. The treatment preferably occurs by coating and/or impregnating the water resistant material in the sheet of graphite particles.

### DESCRIPTION

This is a continuation-in-part of our pending U.S. patent application Ser. No. 09/872,685, titled “Hydrophobic Fuel Cell Component”, filed Jun. 1, 2001, the details of which are incorporated herein by reference.

### TECHNICAL FIELD

This invention relates to a process for manufacturing a material useful for forming a component for an electrochemical fuel cell. The electrochemical fuel cell includes a component formed of graphite sheet which is formed so as to be more hydrophobic than prior graphite sheets suggested for use for electrochemical fuel cell components.

### BACKGROUND OF THE INVENTION

An ion exchange membrane fuel cell, more specifically a proton exchange membrane (PEM) fuel cell, produces electricity through the chemical reaction of hydrogen and oxygen in the air. Within the fuel cell, electrodes denoted as anode and cathode surround a polymer electrolyte to form what is generally referred to as a membrane electrode assembly, or MEA. Oftentimes, the electrodes also function as the gas diffusion layer (or GDL) of the fuel cell. A catalyst material stimulates hydrogen molecules to split into hydrogen atoms and then, at the membrane, the atoms each split into a proton and an electron. The electrons are utilized as electrical energy. The protons migrate through the electrolyte and combine with oxygen and electrons to form water.

A PEM fuel cell includes a membrane electrode assembly sandwiched between two graphite flow field plates. Conventionally, the membrane electrode assembly consists of random-oriented carbon fiber paper electrodes (anode and cathode) with a thin layer of a catalyst material, particularly platinum or a platinum group metal coated on isotropic carbon particles, such as lamp black, bonded to either side of a proton exchange membrane disposed between the electrodes. In operation, hydrogen flows through channels in one of the flow field plates to the anode, where the catalyst promotes its separation into hydrogen atoms and thereafter into protons that pass through the membrane and electrons that flow through an external load. Air flows through the channels in the other flow field plate to the cathode, where the oxygen in the air is separated into oxygen atoms, which joins with the protons through the proton exchange membrane and the electrons through the circuit, and combine to form water. Since the membrane is an insulator, the electrons travel through an external circuit in which the electricity is utilized, and join with protons at the cathode. An air stream on the cathode side is one mechanism by which the water formed by combination of the hydrogen and oxygen is removed. Combinations of such fuel cells are used in a fuel cell stack to provide the desired voltage.

One limiting factor to the use of graphite sheets as components for PEM fuel cells is the relative hydrophilicity of graphite sheets, as compared to other materials. The accumulation of water at or in the electrodes can interfere with operation of the fuel cell. Indeed, since the cathodic side of the fuel cell is the site of water formation during fuel cell operation, the relative hydrophilicity of graphite sheets can cause “flooding” of the cathode, with resulting inoperability of the fuel cell.

Graphites are made up of layer planes of hexagonal arrays or networks of carbon atoms. These layer planes of hexagonally arranged carbon atoms are substantially flat and are oriented or ordered so as to be substantially parallel and equidistant to one another. The substantially flat, parallel equidistant sheets or layers of carbon atoms, usually referred to as graphene layers or basal planes, are linked or bonded together and groups thereof are arranged in crystallites. Highly ordered graphites consist of crystallites of considerable size: the crystallites being highly aligned or oriented with respect to each other and having well ordered carbon layers. In other words, highly ordered graphites have a high degree of preferred crystallite orientation. It should be noted that graphites possess anisotropic structures and thus exhibit or possess many properties that are highly directional such as thermal and electrical conductivity.

Briefly, graphites may be characterized as laminated structures of carbon, that is, structures consisting of superposed layers or laminae of carbon atoms joined together by weak van der Waals forces. In considering the graphite structure, two axes or directions are usually noted, to wit, the “c” axis or direction and the “a” axes or directions. For simplicity, the “c” axis or direction may be considered as the direction perpendicular to the carbon layers. The “a” axes or directions may be considered as the directions parallel to the carbon layers or the directions perpendicular to the “c” direction. The graphites suitable for manufacturing flexible graphite sheets possess a very high degree of orientation.

As noted above, the bonding forces holding the parallel layers of carbon atoms together are only weak van der Waals forces. Natural graphites can be treated so that the spacing between the superposed carbon layers or laminae can be appreciably opened up so as to provide a marked expansion in the direction perpendicular to the layers, that is, in the “c” direction, and thus form an expanded or intumesced graphite structure in which the laminar character of the carbon layers is substantially retained.

Graphite flake which has been greatly expanded and more particularly expanded so as to have a final thickness or “c” direction dimension which is as much as about 80 or more times the original “c” direction dimension can be formed without the use of a binder into cohesive or integrated sheets of expanded graphite, e.g. webs, papers, strips, tapes, foils, mats or the like (typically referred to as “flexible graphite”). The formation of graphite particles which have been expanded to have a final thickness or “c” dimension which is as much as about 80 times or more the original “c” direction dimension into integrated flexible sheets by compression, without the use of any binding material, is believed to be possible due to the mechanical interlocking, or cohesion, which is achieved between the voluminously expanded graphite particles.

In addition to flexibility, the sheet material, as noted above, has also been found to possess a high degree of anisotropy with respect to thermal and electrical conductivity due to orientation of the expanded graphite particles and graphite layers substantially parallel to the opposed faces of the sheet resulting from very high compression, e.g. roll pressing. Sheet material thus produced has excellent flexibility, good strength and a very high degree of orientation.

Briefly, the process of producing flexible, binderless anisotropic graphite sheet material, e.g. web, paper, strip, tape, foil, mat, or the like, comprises compressing or compacting under a predetermined load and in the absence of a binder, expanded graphite particles which have a “c” direction dimension which is as much as about 80 or more times that of the original particles so as to form a substantially flat, flexible, integrated graphite sheet. The expanded graphite particles that generally are worm-like or vermiform in appearance, once compressed, will maintain the compression set and alignment with the opposed major surfaces of the sheet. The density and thickness of the sheet material can be varied by controlling the degree of compression. The density of the sheet material can be within the range of from about 0.04 g/cc to about 2.0 g/cc. The flexible graphite sheet material exhibits an appreciable degree of anisotropy due to the alignment of graphite particles parallel to the major opposed, parallel surfaces of the sheet, with the degree of anisotropy increasing upon roll pressing of the sheet material to increased density. In roll pressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal and electrical properties of the sheet are very different, by orders of magnitude, for the “c” and “a” directions.

### SUMMARY OF THE INVENTION

The present invention provides a process for manufacturing a material useful for forming a component for a PEM fuel cell. Included as components manufactured using the material and the process of the present invention are gas diffusion layers and flow field plates.

The gas diffusion layer material is formed of a sheet of a compressed mass of expanded graphite particles having a plurality of transverse fluid channels passing through the sheet between first and second opposed surfaces of the sheet. The transverse fluid channels are advantageously formed by mechanically impacting an opposed surface of the graphite sheet to displace graphite within the sheet at predetermined locations to provide a channel pattern. The transverse fluid channels thusly formed are adjacently positioned and separated by walls of compressed expanded graphite. The flow field plate material is formed of a sheet of a compressed mass of expanded graphite particles, to form a flow field plate therefrom. At least one of the opposed surfaces of the sheet has a plurality of transverse grooves in a selected pattern to receive a pressurized fuel or pressurized oxidant. The plurality of transverse grooves may be formed by embossing an opposed surface of the graphite sheet to displace graphite within the sheet at predetermined locations to provide the grooved pattern.

The inventive material, whether destined for use as a gas diffusion layer or a flow field plate, is rendered more hydrophobic by the coating thereon and/or impregnating therein of a water-resistant additive, without substantially degrading those properties desirable for use of the graphite sheet in a PEM fuel cell.

More specifically, an embodiment of the present invention is a process for manufacturing a material useful for forming a component of a PEM fuel cell, comprising: (a) providing a sheet of a compressed mass of expanded graphite particles having first and second parallel, opposed surfaces; (b) treating the sheet with a water resistant additive in order to render it more hydrophobic than an untreated sheet to form a treated sheet; and (c) forming the sheet into a PEM fuel cell component.

Another embodiment of the present invention is a process for manufacturing a material useful for forming a component for an electrochemical fuel cell, comprising (a) providing a sheet of a compressed mass of expanded graphite particles having first and second parallel, opposed surfaces; (b) impregnating said sheet with a resin; (c) curing said sheet; and (d) applying 0.2-10 weight % coat of a fluoropolymer material.

Another embodiment of the present invention is a process for manufacturing a material useful for forming a component for an electrochemical fuel cell, comprising (a) providing a sheet of a compressed mass of expanded graphite particles having first and second parallel, opposed surfaces; (b) treating the sheet with 0.2-30 weight % of a fluoropolymer material to render it more hydrophobic than an untreated sheet. In this embodiment, step (b) may be performed by either impregnating or coating said sheet.

Finally, another embodiment of the present invention is a process for manufacturing a material useful for forming a component for an electromechanical fuel cell, comprising (a) providing a sheet of a compressed mass of expanded graphite particles having first and second parallel, opposed surfaces; (b) impregnating the sheet with a resin selected from the group consisting of epoxy-,phenolic- or acrylic-based resins; and (c) impregnating the sheet with 0.2-30 weight % of a fluoropolymer material to render it more hydrophobic than an untreated sheet.

### BRIEF DESCRIPTION OF THE DRAWINGS

FIG. 1 is a plan view of a transversely permeable sheet of graphite having transverse channels which is suitable for use as a gas diffusion layer material in accordance with the present invention.

FIG. 1 (A) shows a flat-ended protrusion element used in making the channels in the channeled sheet of FIG. 1.

FIG. 2 is a side elevation view in section of the sheet of FIG. 1.

FIGS. 2(A), (B), (C) show various suitable flat-ended configurations for transverse channels in gas diffusion layers in accordance with the present invention.

FIG. 3 shows a mechanism for making the article of FIG. 1.

FIG. 4 is a sketch of an enlarged elevation view of an article formed of graphite sheet suitable for use to form a gas diffusion layer in accordance with the present invention.

FIGS. 5, 5A show a portion of a sheet of graphite in accordance with the present invention which has been mechanically deformed into a grooved plate useful for forming a flow field plate in a PEM fuel cell.

FIGS. 6, 7 and 7(A) show a PEM fuel cell which includes components manufactured in accordance with the present invention.

### DETAILED DESCRIPTION OF THE INVENTION

Graphite is a crystalline form of carbon comprising atoms covalently bonded in flat layered planes with weaker bonds between the planes. In obtaining source materials such as the above flexible sheets of graphite, particles of graphite, such as natural graphite flake, are typically treated with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite decomposes and volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact.

Graphite starting materials for the flexible sheets suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as carbons prepared by chemical vapor deposition and the like. Natural graphite is most preferred.

The graphite starting materials for the flexible sheets used in the present invention may contain non-carbon components so long as the crystal structure of the starting materials maintains the required degree of graphitization and they are capable of exfoliation. Generally, any carbon-containing material, the crystal structure of which possesses the required degree of graphitization and which can be exfoliated, is suitable for use with the present invention. Such graphite preferably has an ash content of less than six weight percent. More preferably, the graphite employed for the present invention will have a purity of at least about 98%. In the most preferred embodiment, the graphite employed will have a purity of at least about 99%.

A common method for manufacturing graphite sheet is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. Although less preferred, the intercalation solution may contain metal halides such as ferric chloride, and ferric chloride mixed with sulfuric acid, or a halide, such as bromine as a solution, of bromine and sulfuric acid or bromine in an organic solvent.

The quantity of intercalation solution may range from about 20 to about 150 pph and more typically about 50 to about 120 pph. After the flakes are intercalated, any excess solution is drained from the flakes and the flakes are water-washed.

Alternatively, the quantity of the intercalation solution may be limited to between about 10 and about 50 pph, which permits the washing step to be eliminated as taught and described in U.S. Pat. No. 4,895,713, the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol,octadecanol, 1-octanol, 2-octanol, decylalcohol, 1,10decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution will be aqueous and will preferably contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After intercalating the graphite flake, and following the blending of the intercalant coated intercalated graphite flake with the organic reducing agent, the blend is exposed to temperatures in the range of 25° to 125° C. to promote reaction of the reducing agent and intercalant coating. The heating period is up to about 20 hours, with shorter heating periods, e.g., at least about 10 minutes, for higher temperatures in the above-noted range. Times of one-half hour or less, e.g., on the order of 10 to 25 minutes, can be employed at the higher temperatures.

The thus treated particles of graphite are sometimes referred to as “particles of intercalated graphite.” Upon exposure to high temperature, e.g. temperatures of at least about 160° C. and especially about 700° C. to 1000° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e. exfoliated, graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact as hereinafter described.

Flexible graphite sheet and foil are coherent, with good handling strength, and are suitably compressed, e.g. by roll-pressing, to a thickness of about 0.075 mm to 3.75 mm and a typical density of about 0.1 to 1.5 grams per cubic centimeter (g/cc). From about 1.5-30% by weight of ceramic additives can be blended with the intercalated graphite flakes as described in U.S. Pat. No. 5,902,762 (which is incorporated herein by reference) to provide enhanced resin impregnation in the final flexible graphite product. The additives include ceramic fiber particles having a length of about 0.15 to 1.5 millimeters. The width of the particles is suitably from about 0.04 to 0.004 mm. The ceramic fiber particles are non-reactive and non-adhering to graphite and are stable at temperatures up to about 1100° C., preferably about 1400° C. or higher. Suitable ceramic fiber particles are formed of macerated quartz glass fibers, carbon and graphite fibers, zirconia, boron nitride, silicon carbide and magnesia fibers, naturally occurring mineral fibers such as calcium metasilicate fibers, calcium aluminum silicate fibers, aluminum oxide fibers and the like.

The flexible graphite sheet can also, at times, be advantageously treated with resin and the absorbed resin, after curing, enhances the moisture resistance and handling strength, i.e. stiffness, of the flexible graphite sheet as well as “fixing” the morphology of the sheet. Suitable resin content is preferably at least about 5% by weight, more preferably about 10 to 35% by weight, and suitably up to about 60% by weight. Resins found especially useful in the practice of the present invention include acrylic-, epoxy- and phenolic-based resin systems, or mixtures thereof. Suitable epoxy resin systems include those based on diglycidyl ether or bisphenol A (DGEBA) and other multifunctional resin systems; phenolic resins that can be employed include resole and novolak phenolics.

As stated above, the present invention relates to a process for manufacturing a material which can be formed into a component for an electrochemical fuel cell. Included as components manufactured using the materials and the process of the present invention are gas diffusion layers and flow field plates.

In one aspect of the practice of this invention graphite sheet is provided with channels, which are preferably smooth-sided, and which pass between the parallel, opposed surfaces of the flexible graphite sheet and are separated by walls of compressed expandable graphite. It is the walls of the flexible graphite sheet that actually abut the ion exchange membrane, when the inventive flexible graphite sheet functions as a gas diffusion layer in an electrochemical fuel cell.

The channels preferably have openings on one of the opposed surfaces that are larger than the openings in the other opposed surface. The channels can have different configurations, which can be formed, for instance, using flat-ended protrusion elements of different shapes. The smooth flat-ends of the protrusion elements preferably ensure deformation and complete displacement of graphite within the flexible graphite sheet, i.e. there are no rough or ragged edges or debris resulting from the channel-forming impact. Preferred protrusion elements have decreasing cross-section in the direction away from the pressing force, such as a roller, to provide larger channel openings on the side of the sheet that is initially impacted. The development of smooth, unobstructed surfaces surrounding channel openings enables the free flow of fluid into and through smooth-sided channels. In a preferred embodiment, openings one of the opposed surfaces are larger than the channel openings in the other opposed surface, e.g. from greater than 1 to about 200 or more times greater in area, and result from the use of protrusion elements having converging sides.

The channels are advantageously formed in the flexible graphite sheet at a plurality of locations by mechanical impact. Thus, a pattern of channels is formed in the flexible graphite sheet. That pattern can be devised in order to control, optimize or maximize fluid flow through the channels, as desired. For instance, the pattern formed in the flexible graphite sheet can comprise selective placement of the channels, as described, or it can comprise variations in channel density or channel shape in order to, for instance, equalize fluid pressure along the surface of the gas diffusion layer when in use, as well as for other purposes which would be apparent to the skilled artisan.

The impact force is preferably delivered using a patterned roller, suitably controlled to provide well-formed perforations in the graphite sheet. In the course of impacting the flexible graphite sheet to form channels, graphite is displaced within the sheet to disrupt and deform the parallel orientation of the expanded graphite particles. In effect the displaced graphite is being “die-molded” by the sides of adjacent protrusions and the smooth surface of the roller. This reduces the anisotropy in the flexible graphite sheet and thus increases the electrical and thermal conductivity of the sheet in the direction transverse to the opposed surfaces. A similar effect is achieved with frusto-conical and parallel-sided peg-shaped flat-ended protrusions.

As noted above, an electrochemical fuel cell includes a membrane electrode assembly that comprises an ion exchange membrane sandwiched between two gas diffusion layers, at least one of which is formed from the above-described graphite sheet. A typical substrate for the ion (or proton) exchange membrane (“PEM”) is a porous material, such as a glass cloth or a polymeric material such as a porous polyolefin like polyethylene or polypropylene. Preferably, for use in a commercially practical electrochemical fuel cell, the substrate for the PEM should be between about 10 and 200 microns thick, with an average pore diameter of about 0.1 to about 1.0 microns and porosity of about 50 to 98%. Perfluorinated polymers, like polytetrafluoroethylene, are sometimes preferred. The substrate can then be impregnated to control properties such as porosity. Styrene impregnants such as trifluorostyrene and substituted trifluorostyrenes have been suggested as particularly suitable for use in fuel cell proton exchange membranes. One preferred impregnant useful in the practice of the invention is available from Ion Power Inc. under the tradename Liquione-1100; an especially preferred impregnant is a perfluorinated polymer membrane sold under the tradename Nafiong® by DuPont Company.

Suitable materials for use as the proton exchange membrane are described in U.S. Pat. Nos. 5,773,480 and 5,834,523, the disclosures of each of which are incorporated herein by reference.

In order to facilitate and/or enable the dissociation/association reactions required for fuel cell operation, a catalyst metal is loaded on the two opposed major surfaces of the PEM. Most commonly, the catalyst is a noble metal like platinum or a platinum group metal, often loaded on graphite or carbon particles. The catalyst can be loaded on the gas diffusion layer or directly to the surface of the PEM, or a catalyst-loaded moiety, such as activated carbon paper can be bonded to either surface of the PEM, as would be familiar to the skilled artisan. In operation, the fluid (i.e., either hydrogen gas or oxygen gas, depending on the “side” of the membrane electrode assembly in question) contacts the catalyst. In the case of hydrogen, on the anodic side of the assembly, the catalyst catalyzes the dissociation of the hydrogen to its constituent protons and electrons; the protons then migrate through the proton exchange membrane, and the electrons are then utilized as electrical energy. In the case of oxygen, on the cathodic side of the assembly, the catalyst catalyzes the association of the protons and electrons, with the oxygen, to form water.

In accordance with the present invention, the graphite sheet to be used to form a gas diffusion layer or flow field plate in a PEM fuel cell, especially at the cathodic side of the cell, is rendered more hydrophobic (as opposed to untreated graphite sheet) in order to help prevent the potential flooding resulting from water formation. To do so, a water resistant additive is used to coat or impregnate the sheet, providing added hydrophobicity while not substantially degrading the useful properties of the sheet. Preferred water resistant additives include fluoropolymers, such as dispersions of polytetrafluoroethylene (i.e., Teflon®) material).

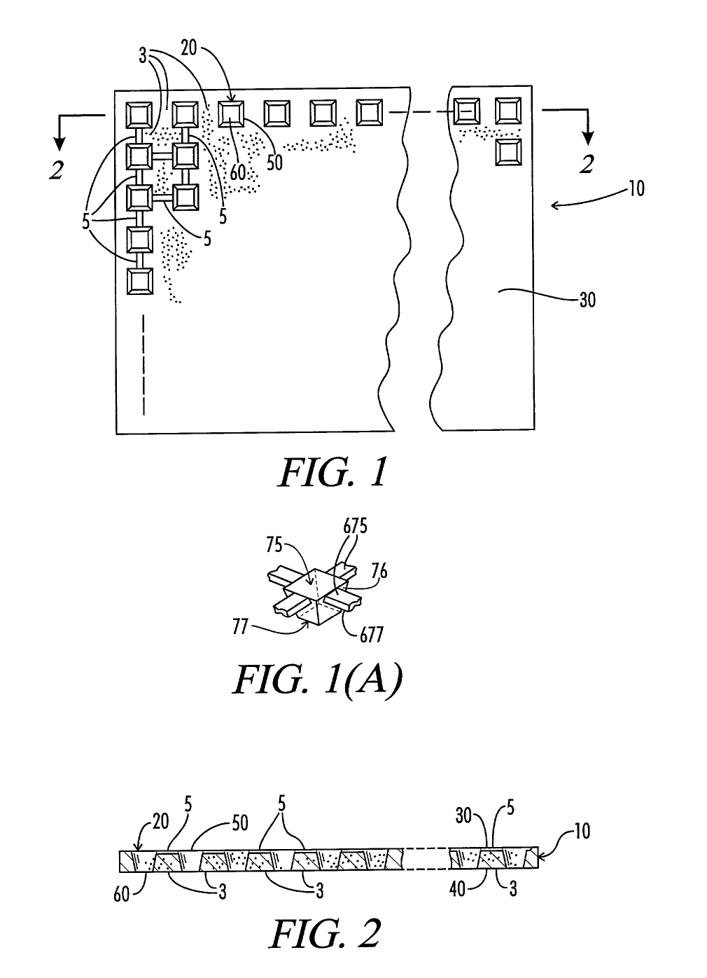

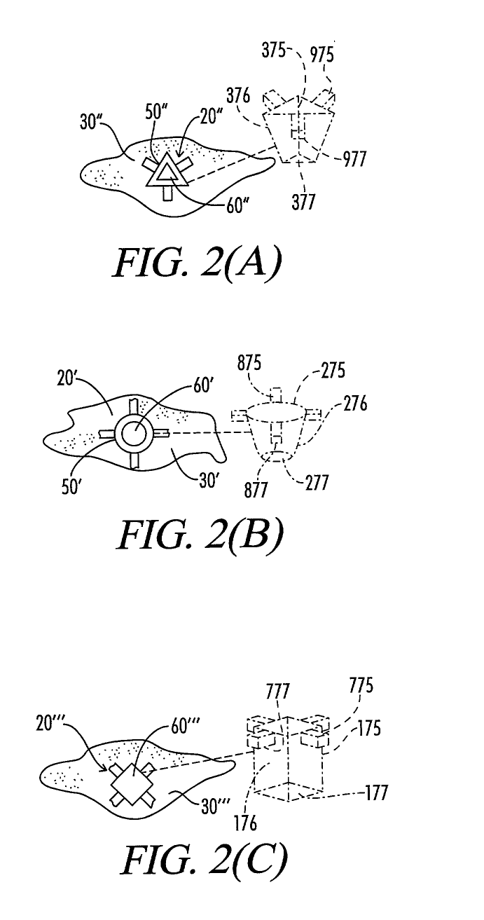

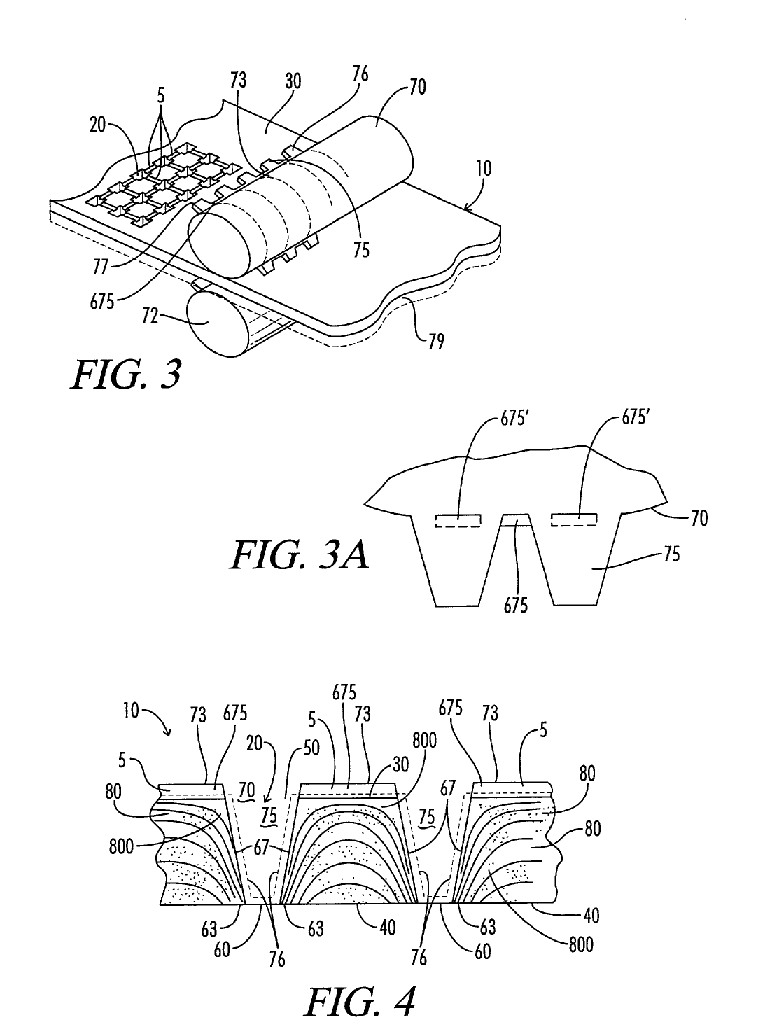

With reference to FIG. 1 and FIG. 2, a compressed mass of expanded graphite particles, in the form of a graphite sheet is shown at 10. In the shown embodiment, to form a material suitable for forming into a PEM fuel cell gas diffusion layer, the flexible graphite sheet 10 is provided with channels 20, which are preferably smooth-sided as indicated at 67, and which pass between the opposed surfaces 30, 40 of flexible graphite sheet 10, and are separated by walls 3 of compressed expandable graphite. The channels 20 preferably have openings 50 on one of the opposed surfaces 30 which are larger than the openings 60 in the other opposed surface 40. The channels 20 can have different configurations as shown at 20′-20′″ in FIGS. 2(A), 2(B), 2(C) which are formed using flat-ended protrusion elements of different shapes as shown at 75, 175, 275, 375 in FIGS. 1(A) and 2(A), 2(B), 2(C), suitably formed of metal, e.g. steel and integral with and extending from the pressing roller 70 of the impacting device shown in FIG. 3. The smooth flat-ends of the protrusion elements, shown at 77, 177, 277, 377, and the smooth bearing surface 73, of roller 70, and the smooth bearing surface 78 of roller 72 (or alternatively flat metal plate 79), ensure deformation and complete displacement of graphite within the graphite sheet, i.e. there are no rough or ragged edges or debris resulting from the channel-forming impact. Preferred protrusion elements have decreasing cross-section in the direction away from the pressing roller 70 to provide larger channel openings on the side of the sheet that is initially impacted. The development of smooth, unobstructed surfaces 63 surrounding channel openings 60, enables the free flow of fluid into and through smooth-sided (at 67) channels 20.

Preferably, in this embodiment, the openings on one of the opposed surfaces are larger than the channel openings in the other opposed surface, e.g. from greater than 1 to about 200 or more times greater in area, and result from the use of protrusion elements having converging sides such as shown at 76, 276, 376. The channels 20 are formed in the graphite sheet 10 at a plurality of pre-determined locations by mechanical impact at the predetermined locations in sheet 10 using a mechanism such as shown in FIG. 3 comprising a pair of steel rollers 70, 72 with one of the rollers having truncated, i.e. flat-ended, prism-shaped protrusions 75 which impact surface 30 of graphite sheet 10 to displace graphite and penetrate sheet 10 to form open channels 20. In practice, both rollers 70, 72 can be provided with 37 out-of-register” protrusions, and a flat metal plate indicated at 79, can be used in place of smooth-surfaced roller 72. FIG. 4 is an enlarged sketch of a sheet of graphite 110 that shows a typical prior art orientation of compressed expanded graphite particles 80 substantially parallel to the opposed surfaces 130, 140.

This orientation of the expanded graphite particles 80 results in anisotropic properties in graphite sheets; i.e. the electrical conductivity and thermal conductivity of the sheet being substantially lower in the direction transverse to opposed surfaces 130, 140 (“c” direction) than in the direction (“a” direction) parallel to opposed surfaces 130, 140. In the course of impacting graphite sheet 10 to form channels 20, as illustrated in FIG. 3, graphite is displaced within graphite sheet 10 by flat-ended (at 77) protrusions 75 to push aside graphite as it travels to and bears against smooth surface 73 of roller 70 to disrupt and deform the parallel orientation of expanded graphite particles 80 as shown at 800 in FIG. 4. This region of 800, adjacent channels 20, shows disruption of the parallel orientation into an oblique, non-parallel orientation is optically observable at magnifications of 100× and higher. In effect the displaced graphite is being “die-molded” by the sides 76 of adjacent protrusions 75 and the smooth surface 73 of roller 70 as illustrated in FIG. 3. This reduces the anisotropy in flexible graphite sheet 10 and thus increases the electrical and thermal conductivity of sheet 10 in the direction transverse to the opposed surfaces 30, 40. A similar effect is achieved with frusto-conical and parallel-sided peg-shaped flat-ended protrusions 275 and 175.

Although it is possible to treat graphite sheet 10 (and, more particularly, graphite sheet 10 intended to be used as the cathode in electrochemical fuel cell 500) with the water resistant additive prior to the formation of channels 20, it is preferred to treat sheet 10 after channels 20 are formed. Moreover, graphite sheet 10 can be treated with the water resistant additive either before or after resin curing, although prior to resin curing is more desirable. For instance, a resin-impregnated graphite sheet 10, treated in accordance with the present invention, can be cured to at least about 250° C., more advantageously at least about 350° C. for at least about 30 minutes. If sheet 10 is not resin-impregnated, curing is typically at least about 350° C for at least about 30 minutes.

Graphite sheet 10 can be provided with increased hydrophobicity by treating with the water resistant additive via a variety of treatment regimen. For instance, sheet 10 can be impregnated by the water resistant additive by spraying sheet 10 with or dipping sheet 10 in a dispersion (such as an aqueous dispersion) of the water resistant additive. Particular water resistant additives include fluoropolymers like perfluoroalkoxy copolymers like a polytetrafluoroethylene/propyl vinyl ether copolymer (PTFE-PPVE) commercially available as PFA TE946 from E.I. du Pont de Nemours and Company of Wilmington, Del. or other commercially available fluoropolymer compositions like Zonyl 8300, also available from du Pont. The water resistant additive can be included in the dispersion at any levels suitable to achieve the desired hydrophobicity to graphite sheet 10. Typically, the dispersion will comprise about 0.2% to about 60% or higher of the water resistant additive. More typically, the dispersion comprises about 5% to about 35% water resistant additive.

The primary criteria for the amount of water resistant additive to be applied to graphite sheet 10 is the added hydrophobicity of sheet 10 while maintaining the desirable criteria for use of sheet 10 as a cathode in electrochemical fuel cell 500. Generally, graphite sheet 10 should have between about 0.2% and about 30% by weight water resistant additive and in some embodiments preferably between about 0.2% and about 10% by weight water resistant additive, in order to achieve the desired characteristics.

To form graphite sheet material like that discussed above into a flow field plate for a PEM fuel cell, the material will preferably formed by embossing a sheet of resin impregnated graphite material between a pair of embossing rollers.

In a typical resin impregnation step, the graphite sheet is passed through a vessel and impregnated with the resin system from, e.g. spray nozzles, the resin system advantageously being “pulled through the mat” by means of a vacuum chamber. The resin is thereafter preferably dried, reducing the tack of the resin and the resin-impregnated sheet, which has a starting density of about 0.1 to about 1.1 g/cc, is thereafter processed to change the void condition of the sheet. By void condition is meant the percentage of the sheet represented by voids, which are generally found in the form of entrapped air. Generally, this is accomplished by the application of pressure to the sheet (which also has the effect of densifying the sheet) so as to reduce the level of voids in the sheet, for instance in a calender mill or platen press. Advantageously, the graphite sheet is densified to a density of at least about 1.3 g/cc (although the presence of resin in the system can be used to reduce the voids without requiring densification to so high a level).

The void condition can be used advantageously to control and adjust the morphology and functional characteristics of the final embossed article. For instance, thermal and electrical conductivity, permeation rate and leaching characteristics can be effected and potentially controlled by controlling the void condition (and, usually, the density) of the sheet prior to embossing. Thus, if a set of desired characteristics of the final embossed article is recognized prior to manipulation of the void condition, the void condition can be tailored to achieve those characteristics, to the extent possible.

Advantageously, especially when the final embossed article is intended for use as a component in an electrochemical fuel cell, the resin-impregnated graphite sheet is manipulated so as to be relatively void-free, to optimize electrical and thermal conductivities. Generally, this is accomplished by achieving a density of at least about 1.4 g/cc, more preferably at least about 1.6 g/cc (depending on resin content), indicating a relatively void-free condition.

The calendered graphite sheet is then passed through an embossing apparatus, and thereafter heated in an oven to cure the resin. Depending on the nature of the resin system employed, and especially the solvent type and level employed (which is advantageously tailored to the specific resin system, as would be familiar to the skilled artisan), a vaporization drying step may be included prior to the embossing step. In this drying step, the resin impregnated graphite sheet is exposed to heat to vaporize and thereby remove some or all of the solvent, without effecting cure of the resin system. In this way, blistering during the curing step, which can be caused by vaporization of solvent trapped within the sheet by the densification of the sheet during surface shaping, is avoided. The degree and time of heating will vary with the nature and amount of solvent, and is preferably at a temperature of at least about 65° C. and more preferably from about 80° C. to about 95° C. for about 3 to about 20 minutes for this purpose.

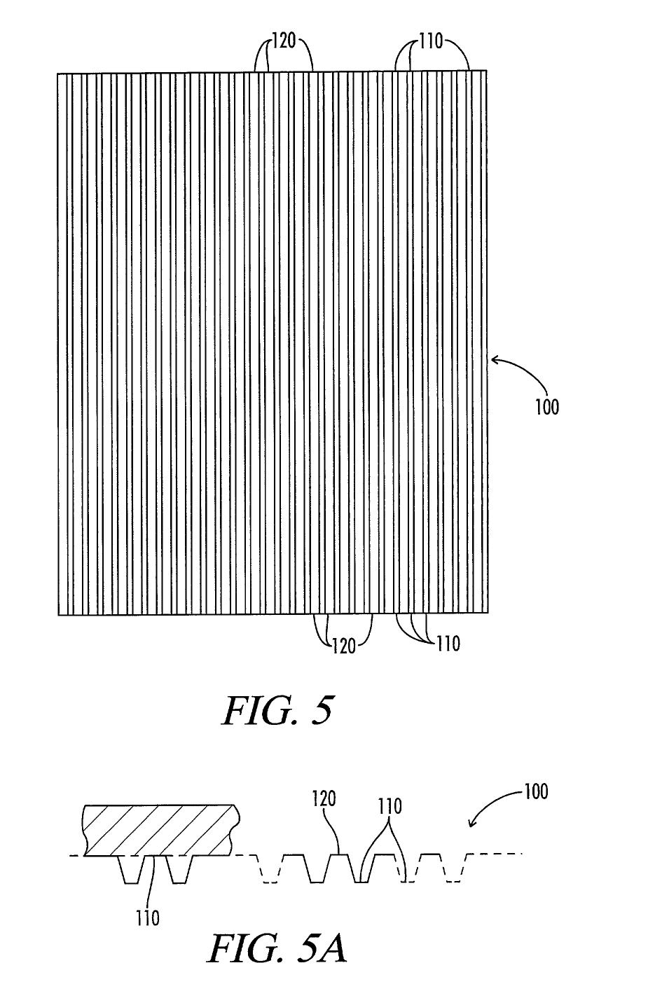

A schematic view of a flow field plate 100, formed by such an embossing process, is shown in top view in FIG. 5 and in side view in FIG. 5(A). The plate 100 depicted has multiple grooves 110 separated by walls 120.

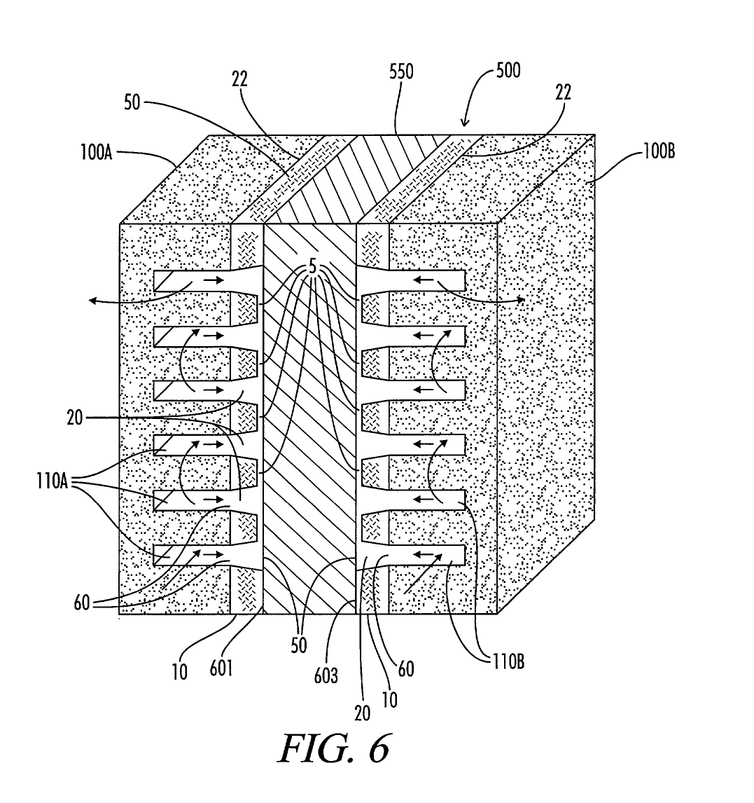

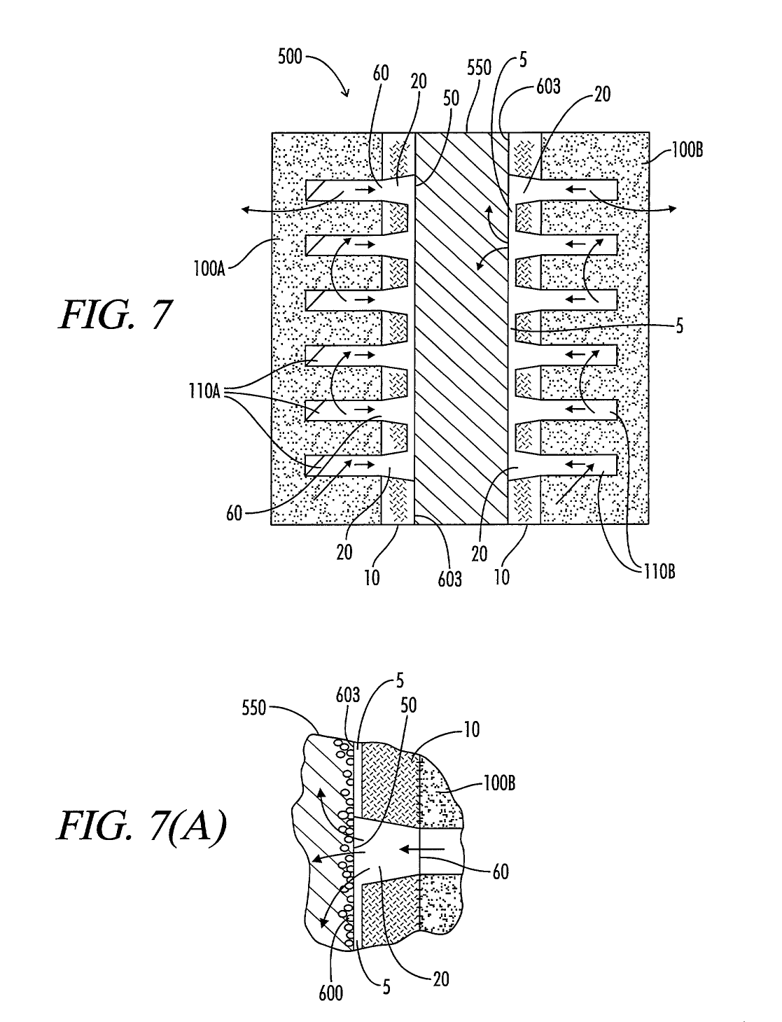

With reference to FIG. 6, FIG. 7 and FIG. 7(A), the Fuel Cell indicated generally at 500, comprises electrolyte in the form of a plastic e.g. a solid polymer ion exchange membrane 550; channeled graphite sheet gas diffusion layers 10 in accordance with the present invention; and flow field plates 100A and 100B respectively abut gas diffusion layers 10. Pressurized fuel is circulated through grooves 110A of fuel flow field plate 100A and pressurized oxidant is circulated through grooves 110B of flow field plate 100B. In operation, the fuel flow field plate 100A becomes an anode, and the oxidant flow field plate 100B becomes a cathode with the result that an electric potential, i.e. voltage is developed between the fuel flow field plate 100A and the oxidant flow field plate 100B. The above described electrochemical fuel cell is combined with others in a fuel cell stack to provide the desired level of electric power as described in the above-noted U.S. Pat. No. 5,300,370.

Summary of Manufacturing Processes

The following summary of processes is applicable generally to the manufacture of materials useful to form components of fuel cells such as flow field plates and gas diffusion layers.

The present invention provides three specific processes for the manufacture of more hydrophobic fuel cell components.

A first process comprises:

(a) providing a sheet of compressed mass of expanded graphite particles having first and second parallel, opposed surfaces;

(b) impregnating the sheet with resin;

(c) curing the sheet; and

(d) applying an about 0.2 to about 10 weight percent coat of a water resistant additive.

A second process comprises:

(a) providing a sheet of a compressed mass of expanded graphite particles having first and second parallel, opposed surfaces; and

(b) either coating or impregnating the sheet with from about 0.2 to about 10 weight percent of a water resistant additive to render it more hydrophobic than an untreated sheet.

A third specific process comprises:

(a) providing a sheet of a compressed mass of expanded graphite particles having first and second parallel, opposed surfaces;

(b) at least partially impregnating the sheet with a resin; and

(c) impregnating the sheet with a water resistant additive which results in from about 0.2 to about 30 weight percent of the water resistant additive in the finished article, to render the finished article more hydrophobic than an untreated article.

For each of the three specific processes discussed above, the water resistant additive, which preferably is a polytetrafluoroethylene material, should be sintered at about 400° C. for a very short time.

All patents and publications cited in the application are expressly incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A process for manufacturing a material useful for forming a component for a fuel cell, comprising:
(a) providing a sheet of a compressed mass of expanded graphite particles having first and second parallel, opposed surfaces;
(b) treating the sheet with a water resistant additive in order to render it more hydrophobic than an untreated sheet to form a treated sheet; and
(c) forming the sheet into a component for a fuel cell.

2. The process of claim 1, wherein step (c) includes forming on one of said opposed surfaces a plurality of transverse grooves in a selected pattern.

3. The process of claim 1, wherein the water resistant additive comprises a fluoropolymer.

4. The process of claim 1, wherein the water resistant additive comprises a polytetrafluoroethylene material.

5. The process of claim 1, wherein
step (c) further includes:
(c) (1) impregnating said sheet with a resin;
(c) (2) embossing a predetermined pattern of transverse grooves; and
(c) (3) curing said sheet; and
step (b) includes applying a coat of a fluoropolymer material resulting in from about 0.2 to about 10 weight % of fluoropolymer material in the component for a fuel cell.

6. The process of claim 1, wherein step (b) further comprises:
impregnating said sheet with a fluoropolymer material resulting in from about 0.2 to about 30 weight % of fluoropolymer material in the component for a fuel cell.

7. The process of claim 1, wherein step (b) further comprises:
coating said sheet with a fluoropolymer material resulting in from about 0.2 to about 30 weight % of fluoropolymer material in the component for a fuel cell.

8. The process of claim 1, further comprising:
after step (a), at least partially impregnating said sheet with resin; and
wherein step (b) includes impregnating said sheet with 0.2-30 weight % of a fluoropolymer material.

9. The process of claim 1, further comprising:
sintering the treated sheet.

10. A process for manufacturing a material useful for forming a component for an electrochemical fuel cell, comprising:
(a) providing a sheet of a compressed mass of expanded graphite particles having first and second parallel, opposed surfaces;
(b) impregnating said sheet with a resin;
(c) curing said sheet; and
(d) applying about 0.2-10 weight % coat of a water resistant additive.

11. The process of claim 10, further comprising, after step (b):
embossing a predetermined pattern of transverse grooves.

12. The process of claim 10, wherein the water resistant additive is a fluoropolymer material.

13. The process of claim 10, further comprising:
after step (d), sintering the sheet.

14. A process for manufacturing a material useful for forming a component for an electrochemical fuel cell, comprising:
(a) providing a sheet of a compressed mass of expanded graphite particles having first and second parallel, opposed surfaces; and
(b) impregnating the sheet with about 0.2-30 weight % of a water resistant additive to render it more hydrophobic than an untreated sheet.

15. The process of claim 14, wherein the water resistant additive is a fluoropolymer material.

16. The process of claim 14, further comprising:
after step (b), sintering the sheet.

17. A process for manufacturing a material useful for forming a component for an electrochemical fuel cell, comprising:
(a) providing a sheet of a compressed mass of expanded graphite particles having first and second parallel, opposed surfaces; and
(b) coating the sheet with about 0.2-30 weight % of a water resistant additive to render it more hydrophobic than an untreated sheet.

18. The process of claim 17, wherein the water resistant additive is a fluoropolymer material.

19. The process of claim 17, further comprising:
after step (b), sintering the sheet.

20. A process for manufacturing a material useful for forming a component for an electrochemical fuel cell, comprising:
(a) providing a sheet of a compressed mass of expanded graphite particles having first and second parallel, opposed surfaces;
(b) at least partially impregnating the sheet with a resin; and
(c) impregnating the sheet with about 0.2-30 weight % of a water resistant additive to render it more hydrophobic than an untreated sheet.

21. The process of claim 20, wherein the water resistant additive is a fluoropolymer material.

22. The process of claim 20, further comprising:
after step (c), sintering the sheet.
